(19) United States
(12) Patent Application Publication
(10) Pub. No.: US 2010/0243885 A1
(43) Pub. Date: Sep. 30, 2010

(54) METHODS AND APPARATUS FOR EXTRACTING AIR CONTAMINANTS

(75) Inventors: Gary C. Tepper, Glen Allen, VA (US); Royal Kessick, Richmond, VA (US)

Correspondence Address: LAW OFFICE OF MICHAEL P. EDDY;MICHAEL P. EDDY, 12526 HIGH BLUFF DRIVE, STE. 300, SAN DIEGO, CA, 92130, US

(73) Assignee: SENTOR TECHNOLOGIES, INC., Glen Allen, VA (US)

(21) Appl. No.: 12/412,339

(22) Filed: Mar. 26, 2009

(51) Int. Cl. B01D 59/46

(52) U.S. Cl. 250/284; 250/288

(57) ABSTRACT

In accordance with the present invention there are provided methods and devices for ozone-free electrostatic extraction of contaminating particles. The devices include spatially separated areas of particle ionization by electrospraying and of electrostatic particles precipitation. Electrospray sources include arrays of porous polymer wicks and porous polymeric ribbons.

### CROSS-REFERENCE TO RELATED APPLICATIONS

The subject matter described in the present application is related to that described in the U.S. patent application Ser. No. 11/276,355 to Tepper et al. filed Feb. 24, 2006, now pending, which is incorporated by reference herein in its entirety.

### STATEMENT AS TO FEDERALLY SPONSORED RESEARCH

This invention resulted from research funded in whole or part by the Defense Threat Reduction Agency, ARO Contract No. W911NF-06-C-0164 and by the U.S. Army under STTR Contract No. W9132V-04-C-0023. The federal government has certain rights in this patent application.

### FIELD OF THE INVENTION

This invention relates generally to the field of air purification. More specifically, the invention relates to electrostatic precipitation (ESP) based methods and apparatuses useful for air purification.

### BACKGROUND

Air purification systems employing the process of electrostatic precipitation (ESP) have been used in both industrial and commercial applications. A typical system utilizes a corona discharge to ionize air contaminants and a series of metal plates to collect the so ionized species. The ESP systems combine the quietude of operation and low maintenance costs, such as having no need to replace filter. However, the corona ionization process produces ozone and, accordingly, causes health concerns, thus undermining the usefulness of such corona-discharge based devices.

Previous attempts to create an improve ESP based systems were only partially successful, at best. In some of such previous systems, the particle ionization and collection steps were integrated. The overall particle removal efficiencies were quite promising and clean air delivery rates (CADR) greater than 100 for both dust and cigarette smoke were achieved. The CADR number, typically, should be at least ⅔ the square footage of the room being purified, and is used by the Association of Home Appliance Manufacturers to quantify and compare the performance of commercial air purification systems.

However, using such integrated systems makes it difficult to separately control particle ionization and collection efficiencies. Accordingly, there is a need for improved devices and methods useful for air purification, such as systems with separate particle ionization and collection regions. The present application provides some of such improved methods and devices.

### SUMMARY

According to one aspect of the invention an apparatus for extracting contaminants from an air flow is provided, the apparatus including an ionization region serving also as an air channel, i.e., a conduit for an air flow containing contaminants, a reservoir containing an aqueous composition connected to the ionization region, electrospray source(s) connected to the aqueous composition reservoir, a precipitation region comprising an electrostatic precipitator for particle collection in communication with the ionization region, and an electric field generator for generating electric fields in the ionization region and the precipitation region, wherein the electric field in the ionization region is is controlled independently from the electric field in the precipitation region.

According to another aspect of the invention, the plurality of the contaminants become electrically charged upon the entry of the air flow into the air channel upon contact with the charged liquid droplets that are dispersed into the ionization region. The charged contaminants are expelled into the precipitation region and are collected on the electrostatic precipitator.

According to yet another aspect of the invention, the ionization region and the precipitation region are not situated in the same area, i.e., the ionization region and the precipitation region are spatially separated.

According to still further other aspects of the invention, the electrospray charged droplet source comprises porous polymeric wicks or porous polymer ribbons.

According to yet other aspects of the invention, a method for extracting contaminants from an air flow is provided, the method comprising directing the air flow through the ionization region of the above-described device, creating an electric field in the ionization region for generating and dispersing in the ionization region a plurality of charged liquid droplets. The charged liquid droplets are allowed to interact with the particles of the contaminants being present in the air flow, thus transferring the charge from the charged liquid droplets to the particles of the contaminants, followed by expelling the charged containments into the precipitation region, and collecting the charged containments on the electrostatic precipitator.

According to yet another aspect of the invention, the above-described process of generating the charged droplets does not produce an appreciable quantity of ozone.

### BRIEF DESCRIPTION OF THE DRAWINGS

FIG. 1 shows schematically a contaminant extraction apparatus according to one embodiment of the present invention.

FIG. 2 shows schematically a contaminant extraction apparatus according to another embodiment of the present invention.

FIG. 3 shows schematically a tri-dimensional view of ionization and collection regions in a contaminant extraction apparatus according to an embodiment of the present invention.

FIG. 4 shows schematically a tri-dimensional view of ionization and collection regions in a contaminant extraction apparatus according to another embodiment of the present invention.

FIG. 5, is a graph showing the particle collection efficiency for 3 different particle sizes versus the total electrospray current for a device shown by FIG. 3.

FIG. 6 is a graph showing the particle collection efficiency for 3 different particle sizes versus the collector voltage for a device shown by FIG. 1.

FIG. 7 is a graph showing the particle collection efficiency for several different collector voltages versus air flow rate, and a specific particle size, for a device according to an embodiment of the present invention.

FIG. 8 shows schematically a contaminant extraction apparatus according to another embodiment of the present invention.

FIG. 9 shows schematically a contaminant extraction apparatus according to yet another embodiment of the present invention, the apparatus including electrospray source having porous polymer ribbons.

FIG. 10 shows schematically the relative positions of the electrospray source having porous polymer ribbons and the electrospray aerosol, for the device shown by FIG. 9.

FIG. 11 is a graph showing a plot of the electrospray current versus the applied voltage for the device shown by FIG. 9.

FIG. 12 is a plot of the electrospray current versus the applied potential difference for a device according to an embodiment of the present invention.

FIG. 13 is a photograph of a 1 mm diameter Porex wick showing the bonded fiber microstructure.

FIG. 14 is a plot of the particle removal efficiency as a function of collection plate differential voltage for a device according to an embodiment of the present invention.

FIG. 15 is a plot of normalized particle electrical mobility versus particle diameter.

FIG. 16 is a plot of collection efficiency versus electrospray current for a device according to an embodiment of the present invention.

### DETAILED DESCRIPTION

### A. Terms and Definitions

The terms “electrospray” or “electrospraying” refer to a process of dispersing a liquid or a fine aerosol formed as a result of applying an electric field to the liquid. As used in the present application, the term “electrospray” also applies to a device or an apparatus that is used to carry out the process of electrospraying.

The term “electrostatic precipitation” refers to a process of extracting of fine solid particles suspended in a gas or a mixture of several gases, such as, air by electrostatically charging the particles, followed by precipitating the particles on a collector in an electric field.

The term “ionization” region is defined as the region between the electrospray sources and the counter electrode and can have any number of geometries including planar, cylindrical, spherical or a combination thereof.

### B. Embodiments of the Invention

According to embodiments of the present invention, various devices, apparatuses and systems are provided for extracting contaminants from an air flow. In general, such devices include an ionization region serving also as an air channel, i.e., a conduit for an air flow containing contaminants. A reservoir containing an aqueous composition is in communication with the ionization region, and an electrospray source is connected to such reservoir. The electrospray source comprises porous polymeric wick(s) or porous polymer ribbon(s). The porous polymer wick or ribbon sources draw liquid from the reservoir through capillary forces and disperse the liquid into the air channel in the form of a charged electrospray aerosol. The wicks can consist of bundled or bonded fibers or particles from wettable hydrophilic polymers such as polyesther, polyethylene, cellulose or nylon. The average pore size within the polymer wick or ribbon is typically between 1 and 100 microns. A charged electrospray aerosol is formed at the tip of the fully wetted porous polymer wick source which has a typical diameter of between 0.5 and 3 mm. A charged electrospray aerosol sheet is formed from one or both edges of the porous polymer ribbon source. Therefore, the ribbon source is a one dimensional electrospray source while the wick is a point source. The ribbon source has a typical edge thickness of between 0.5 and 3 mm. The length, width and overall geometry of the ribbon source can vary widely depending on the application. For example, a flexible ribbon source can be formed into a curved or circular shape to distribute an electrospray sheet in desired patterns.

A variety of polymers may be utilized for making porous polymeric wicks, to be selected by those having ordinary skill in the art. The polymers should be hydrophilic and fully wettable and can be either natural (e.g. cotton, cellulose) or synthetic (nylon, polyesther). Examples of acceptable polymers include polyethylene, polyesther, nylon, cellulose and cotton having an average pore size of 1 to 100 microns.

The devices further include a precipitation region comprising an electrostatic precipitator for particles collection, where the precipitation region is in communication with the ionization region. The operation of the devices require the presence of electric fields in both the ionization and the precipitation regions; accordingly, an electric field generator is provided for generating such electric fields, and the electric field magnitude in the ionization region is independent of and typically less than the electric field in the precipitation region.

Embodiments of the invention provide for the ionization region and the precipitation region being spatially separated. Those having ordinary skill in the art may select the proper width of the space separating the ionization region and the precipitation region; generally such width may be between about 1 cm and about 20 cm. The spatial separation allows for independent optimization and control of the particle ionization and particle collection functions of the device.

The operation of the devices of the present invention may be briefly described as follows. The plurality of the contaminants becomes electrically charged upon the entry of the air flow into the air channel and upon contact with the charged liquid droplets that are dispersed into the ionization region. The charged contaminants are expelled into the precipitation region and are collected on the electrostatic precipitator.

More specifically, the air flow containing particles of solid contaminants is directed through the ionization region of the device. An electric field is created in the ionization region for the purpose of generating and dispersing in the ionization region a plurality of charged liquid droplets. The process of generating the charged droplets does not produce an appreciable quantity of ozone. An electric field is also created in the precipitation region for the purpose of collecting the charged contaminants and the electric field in the ionization region is independent of and typically of a lesser strength than the electric field in the precipitation region. The difference in the electric field magnitude in the two regions is required for optimum performance because the optimum electric field required to generate the electrospray aerosols in the ionization region is not the same as the optimum electric field necessary to collect the charged contaminants in the collection region.

The charged liquid droplets so formed in the ionization region are then allowed to interact with the particles of the contaminants being present in the air flow, and in this fashion some of the electrical charge from the charged liquid droplets is transferred to the particles of the contaminants. Finally, due at least in part to the difference between the strengths of the electric fields in the ionization and precipitation regions, but also the result of an imposed pressure differential across the device, the charged containments are expelled into the precipitation region, and the charged contaminants are collected on the electrostatic precipitator.

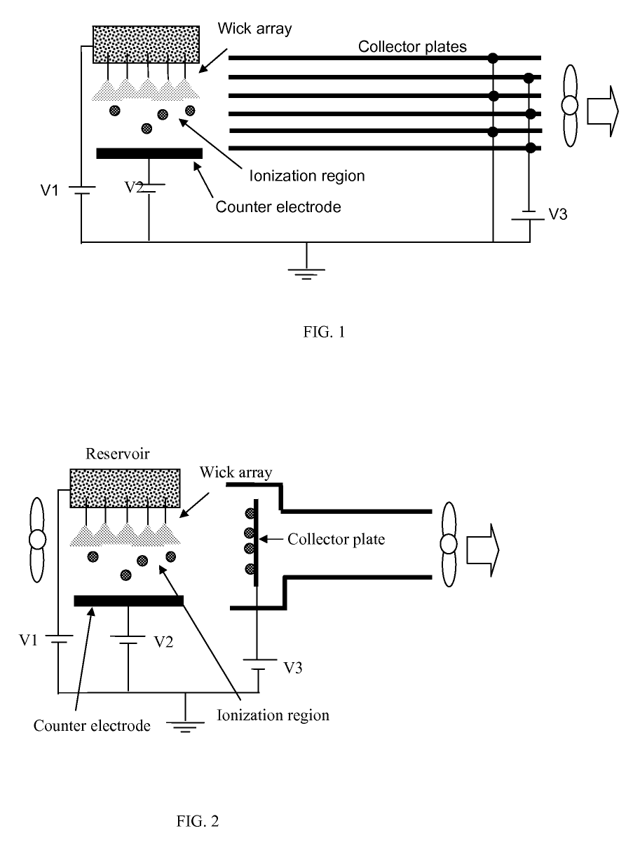

More details concerning the methods, devices and apparatuses according to embodiments of the present invention are provided with the further reference to FIGS. 1-11. More specifically, FIGS. 1 and 2 show schematically a contaminant extraction apparatuses according to two embodiments of the present invention. Each apparatus shown by FIGS. 1 and 2 has an ionization region that is electrically and physically isolated from the particle collection area. FIG. 1 shows the collection plates oriented parallel to the air stream, while FIG. 2 shows the collection plates oriented perpendicular to the air stream lines in order to further improve the collection efficiency through particle impaction.

In both embodiments of FIGS. 1 and 2, independent voltages (V1, V2 and V3) can be applied to the electrospray sources, electrospray counter electrode and the collector plates, respectively. The voltage drop across the ionization region is determined as the difference between V1 and V2 and must be sufficient to produce an electric field magnitude at the electrospray sources large enough to sustain the sprays (typically, greater than about 2 kV/cm). In these embodiments, a fan is used to send contaminated air into the ionization region and through the device. Polar molecules or particles that become ionized by the electrically charged electrospray droplets will, driven by the potential gradient, get collected either on the counter electrode or on the downstream collector plates.

The charged particle electrical mobility is a function of the potential gradient and the particle collection efficiency can be increased by applying a separate voltage or potential (V3) to the collector plate with respect to the voltages used in the ionization region. For example, if V1 and V2 are positive and V1 is greater (more positive) than V2, the contaminants are ionized with a positive polarity and are located initially at a positive potential with respect to V2. The charged contaminants will be mobilized by the electric field or potential gradient and will be driven toward any surface at a lower potential. Therefore, the particle collection efficiency can be increased by applying a voltage (V3) to the collector plates which is at a lower potential than that of V2. The particle collection efficiency can be further increased by imparting an electric field between the parallel collection plates. The electric field between the collection plates is produced by applying a differential bias to alternating plates. For example, in the embodiment shown in FIG. 1, a bias voltage of V3 is applied to alternating plates while the other plates are placed at ground potential.

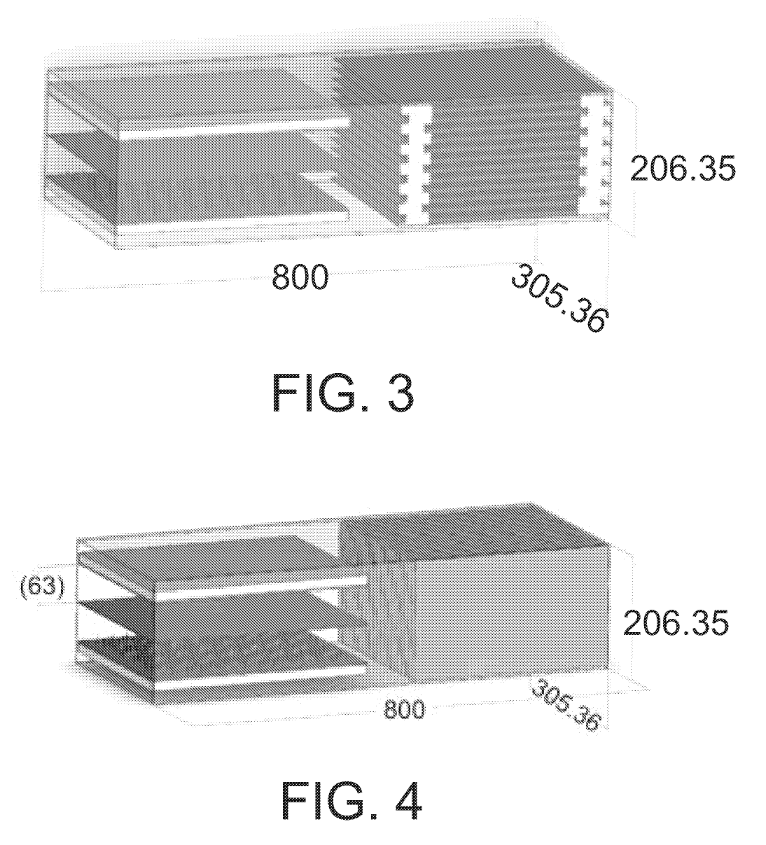

The design of the devices of the invention may be further illustrated by FIGS. 3 and 4. As can be seen, the particle ionization region comprises arrays (of porous polymer wicks directed toward a central counter electrode, one such array pointing up and one pointing down. In the device shown by FIG. 3, the separate collector plates are arranged in horizontal rows, while in the device shown by FIG. 4, the collector plates are arranged in vertical rows.

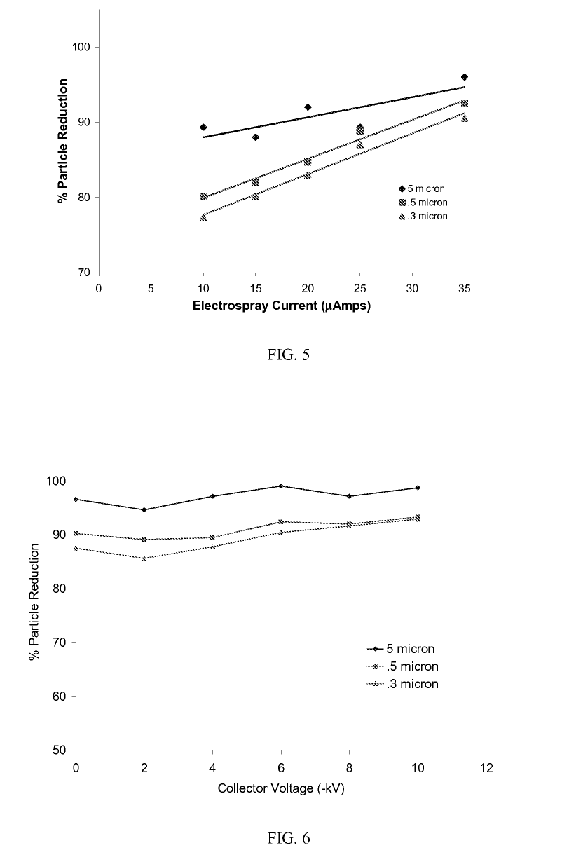

In some instances, prototypes were constructed and reduced to practice. For example, FIG. 5 illustrates a plot of the particle collection efficiency for 3 different particle sizes versus the total electrospray current at an air flow rate of 13.5 cubic feet per minute fir a prototype device constructed according to FIG. 1. FIG. 6 illustrates a plot of the particle collection efficiency versus differential collector voltage for three different particle sizes utilizing a similar prototype device constructed according to FIG. 1.

In the gathering of this data used to prepare the graph shown on FIG. 6, a fan controlled the air flow rate through the prototype at a rate of about 3 cubic feet per minute. The electrospray ionization system consisted of 130 Porex wick sources arranged in a 10×13 inch array and inserted into a polyester wicking reservoir. The distance between the tip of the wicks and the grounded counter electrode was about 52 mm. A positive high voltage was applied to the reservoir in order to initiate and sustain the electrospray array. This voltage ranged from 0 to 17.2 kV and resulted in an electrospray current ranging from 0 to 30 microamps. The electrospray solution was an ethanol solution in water having about 10 mass % of ethanol and the balance of water (i.e., 90/10 water/ethanol system).

The data shown on FIG. 6 show that the particle collection efficiency for all three particle sizes increases with increasing collector plate bias. Although this data was obtained for one particular set of voltages (V1 and V2) and a narrow range of collector voltages (V3), the same effect can be produced under a wide range of V1, V2 and V3 values and polarities.

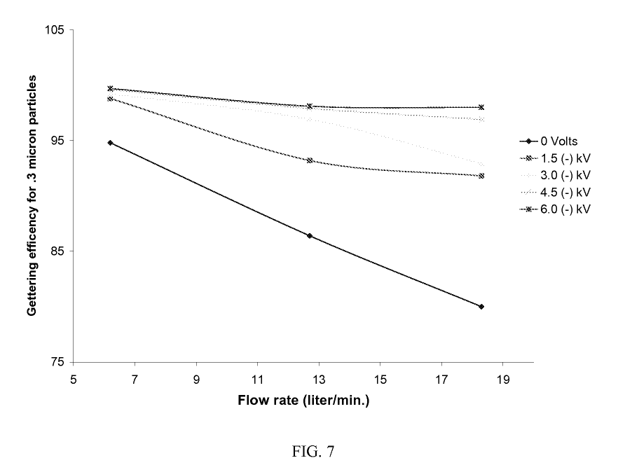

Collection efficiency may be further illustrated with the reference to FIG. 7, which is a plot of the 0.3 micron particle collection efficiency versus air flow rate in a similar prototype at four different values of the collector plate voltage. The data shows that the particle collection efficiency is higher at all flow rates at the higher (more negative) collection plate voltages.

The data shown by FIGS. 6 and 7 thus demonstrate that the air purification efficiency can be increased by implementing embodiments whereby the ionization region and the particle collection regions are separated and maintained at independent potentials in order to independently control and optimize the particle ionization and particle collection functions of the device.

In previous embodiments, a fan is used to direct contaminated air into a region containing one or more electrospray sources. The contaminants become ionized if they encounter one or more of the electrically charged aqueous droplets produced by the one or more electrospray sources. One potential limitation of this design is that the conical electrospray plumes do not cover the entire air channel so that some of the contaminants can move through the channel without becoming ionized resulting in lower air purification efficiency.

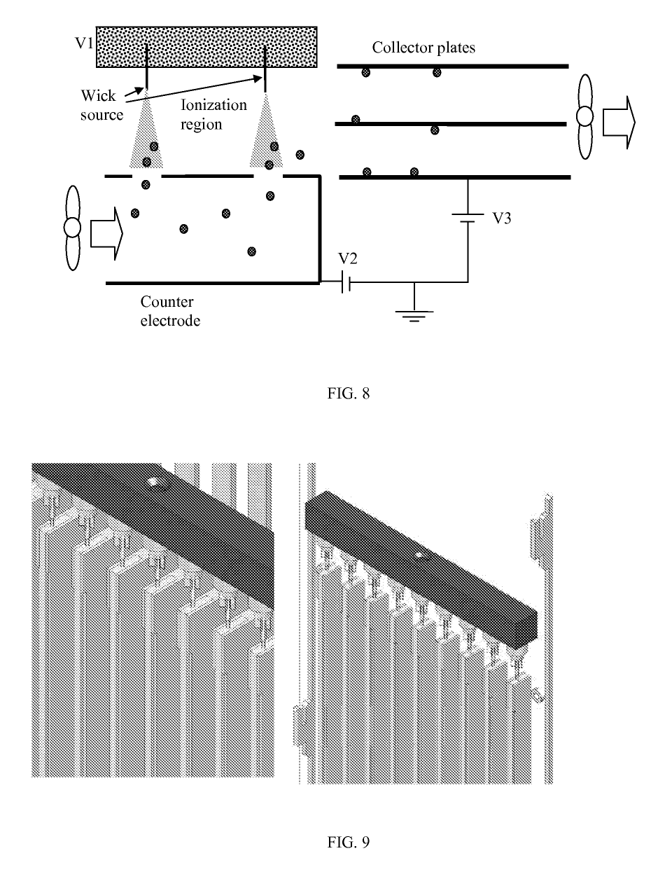

Furthermore, in previous embodiments, the probability of ionization was increased by using multiple, wick electrospray sources to disperse charged droplets over a large volume. However, even this approach may have limits as it can be difficult to disperse charge over the entire ionization region, and further improvements and refinements may be desirable. One such improved embodiment is shown on FIG. 8.

With the reference to FIG. 8, there is provided a schematic diagram illustrating an embodiment wherein the air contaminants are injected through holes in the counter electrode directly into the electrospray plumes, thereby greatly increasing the ionization probability. The holes in the counter electrode are designed to coordinate spatially with the location of individual electrospray sources so that the contaminants entering the ionization region will have a higher probability of encountering a charged droplet and become ionized.

In the embodiment of the device illustrated by FIG. 8, the optimum diameter of the injection holes may be approximately the same diameter as that of the electrospray plume at the location of the counter electrode. If the injection hole diameter is larger than the plume diameter, some of the contaminants will enter the ionization region without encountering a charged droplet. Conversely, if the diameter of the holes is significantly smaller than the diameter of the plume, the velocity of the air through the hole will increase at a given air flow rate due to conservation of mass and the ionization probability will decrease. That is, assuming that the density of air is constant in the flow, the air flow rate through a given hole is the product of the air velocity and the area of the opening. Therefore the velocity must increase as the area decreases in order to maintain a given air flow through the device.

Multiple injection ports, each corresponding to a separate electrospray source can be used to increase the volumetric flow rate of the air through the system. In addition, this design improvement can be implemented in various system geometries. For example, in addition to the planar geometry illustrated by FIG. 8, the counter electrode could consist of a hollow cylinder with injection ports in the walls with each injection port coordinated with an electrospray source emitting from a separate cylindrical reservoir.

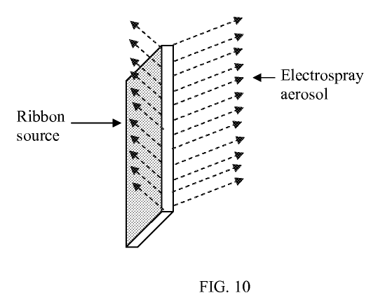

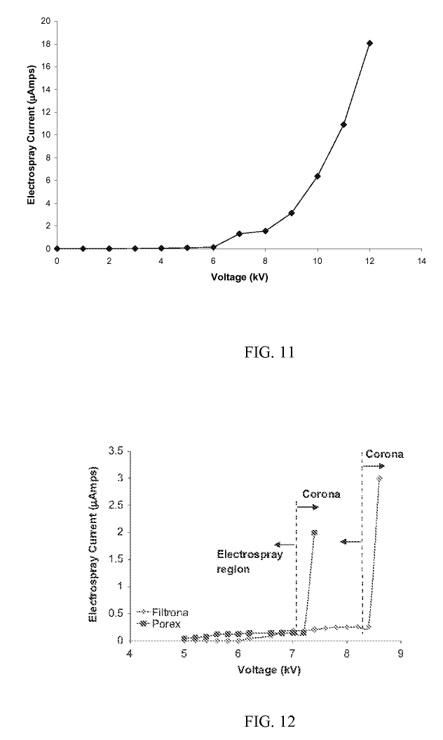

As mentioned above, in some further embodiments, the electrospray source may comprise polymer ribbons (the outer edge shown by FIG. 9). In this case the contaminated air flows between the ribbons from behind and encounters the electrospray aerosol sheet emitted from the downstream edge of the ribbons. The contaminants pick up charge and continue on into the electrostatic precipitator region where they are collected onto the surface of an array of metal plates. FIG. 10 shows schematically what the spatial relation is in the device shown by FIG. 9 between the electrospray source having porous polymer ribbons and the electrospray aerosol. FIG. 11 further demonstrates a plot of the electrospray current versus the applied voltage for a small (two component) ribbon source.

### EXAMPLES

The following examples are provided to further illustrate the advantages and features of the present invention, and as a guide for those skilled in the art, but are not intended to limit the scope of the invention.

### Example 1

### Prototype Systems

Two prototype air purification systems, one small and one large, were constructed and tested. The prototype systems corresponded to the device illustrated by FIG. 1. In each system, particle ionization was accomplished by charge transfer from an aerosol of charged droplets dispersed into an air stream from an array of electrospray polymer wick sources. Wick electrospray sources were employed instead of conventional hollow needles in order to eliminate the need for mechanical components such as syringe pumps and valves and to uniformly distribute the charged aerosols throughout an air flow channel. A wick is self-balancing and, through capillary action, automatically replenishes the solvent dispersed by the electrospray aerosol.

The wicks that were used were made of a microporous, bonded synthetic polymer material from two commercial vendors: Filtrona and Porex Corporations. The wicks from Filtrona were 2 mm in diameter and the wicks from Porex were 1 mm in diameter. The wicks were cut to a length of about 20 mm and wetted by placing one end into a liquid reservoir containing a 90/10 water/ethanol solution. Electrospray was initiated by applying a high voltage between the liquid reservoir and a counter electrode located opposite the wick tip, which could be either blunt or cut to a 45° bevel to enhance the local electric field magnitude.

In both small and large prototypes, the electrospray aerosol emerges from the wick tips and, therefore, the particles in the air flowing around the body of the wick and below the electrospray tips might avoid the charged aerosol and not become ionized. Air fins were used at the entrance to the ionization region in order to direct the incoming air flow into the electrospray aerosols, but no measurable difference in the resulting air purification efficiency was observed. Smoke visualization of the flow revealed that the presence of the sharp wick tips in the channel produces turbulent mixing in the ionization region such that all of the entering streamlines have a high probability of interacting with the charged aerosols. Use of air fins is, therefore, optional.

The particle collection region in prototype A (small) included two parallel square metal plates measuring approximately 30 cm on a side and separated by 2 cm. A negative potential was applied to one of the plates and the second plate was grounded as illustrated in FIG. 1. The particle collection region in the larger prototype B included an array of 19 parallel metal plates 23 cm long and separated by about 7 mm. A negative potential was applied to alternating collection plates with respect to ground.

### Example 2

### Testing and Results

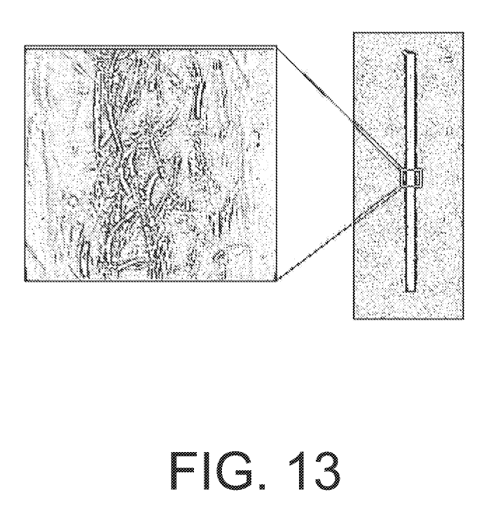

FIG. 12 is a plot of the electrospray current versus the applied potential difference between a blunt wick tip and a grounded counter electrode located at a distance of 1 cm for a 1 mm Porex and 2 mm Filtrona wick. Porex wicks may be obtained from Porex Corp. of Fairburn, Ga. Filtrona wicks may be obtained from Filtrona Fibertec Corp. of Colonial Heights, Va. FIG. 13 is a photograph of a Porex wick illustrating the bonded fiberconstruction. For both wicks, the electrospray current initially increases with applied voltage as expected, but then levels off and stays relatively constant until reaching the point of corona discharge where the current increases dramatically. Due to the higher electric field concentration in the smaller diameter Porex wick, the electrospray initiates at a lower voltage and the onset of corona discharge also occurs at a lower voltage (7.2 kV versus 8.4 kV).

In the smaller system, prototype A, described in Example 1 above, the electrospray ionization region included 44 individual Filtrona wicks arranged in four parallel rows. A positive high voltage of 6.8 kV was applied between the liquid reservoir and a grounded counter electrode located at a distance of 2.6 cm from the wick tips. At this voltage the maximum electrospray current from the 44 component array was 18 μA or about 400 nA per wick.

In the larger system, prototype B, the electrospray ionization region included 440 individual Porex wicks arranged in two square arrays and a grounded counter electrode located at a distance of about 5 cm from the wick tips. A positive high voltage of up to 20 kV was applied between the wick array and the grounded counter electrode producing a maximum electrospray current of about 80 μA or an average of about 180 nA per wick.

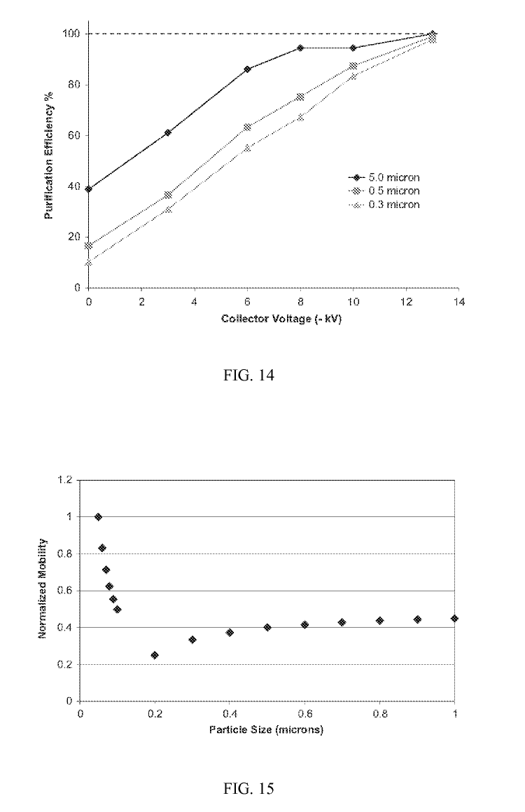

Fans were used to direct ambient air with a measured particle concentration through the ionization region of each prototype and into a separate particle collection region and a particle counter was used to measure the single pass particle removal efficiency, defined as the entering minus exiting particle count divided by the entering count, in each prototype as a function of air flow rate, particle size, and collector plate bias. FIG. 14 is a plot of the particle removal efficiency in prototype A for 0.3, 0.5, and 5 μm particles as a function of collection plate differential voltage at a measured air flow rate of 21.6 l/min. The particle removal efficiency increased monotonically at all particle sizes and approached 100% at a collection plate differential voltage of −8 kV for 5 μm particles and −13 kV for 0.3 and 0.5 μm particles. From the data of FIG. 14, it can be concluded that the particle ionization efficiency, defined as the fraction of particles becoming charged, is very close to 100% for all three particle sizes at this electrospray current and air flow rate. If the ionization efficiency was less than 100%, the particle collection efficiency could not approach 100% even at very high collector plate voltages.

FIG. 15 is a plot of the equation Z=nQ/3πμₖD, where Z is the particle electrical mobility, n is the number of elemental charges on the particle, Q is the magnitude of an elemental unit of charge, μₖ is the kinematic viscosity of air (1.8×10⁻⁵ kg/ms) and D is the particle diameter. The value of n was approximated as n=1 for particles with D<0.2 μm, and n=(11×D−1.2) for particles with D>0.2 μm. The plot on FIG. 15 was normalized such that the maximum particle mobility Z=1. The curve of FIG. 15 predicts that the collection efficiency in electrospray-based electrostatic precipitators will be lowest for singly charged submicron particles with a diameter near 0.2 μm.

In all cases, in order to maximize the collection efficiency, the electric field between the collector plates should be as large as possible, but below the air breakdown field and, for a given air flow rate, the air velocity between the plates can be reduced by using multiple parallel plates with alternating electrical polarity as was used in the collection region of prototype B.

The following design rule was used for maximizing particle collection in systems with parallel collection plates, d/L<(ZₘᵢₙE)/vₘₐₓ, where d/L is the ratio of the collection plate spacing to the collection plate length, Zₘᵢₙ is the electrical mobility of the slowest-moving particles, E is the electric field magnitude between the collection plates, and vₘₐₓ is the maximum air velocity between the plates. Using a Zₘᵢₙ value of 5×10⁻⁵ cm²/Vs, an electric field magnitude of 28 kV/cm and a d/L=0.03, the maximum allowable air velocity through the collection region of prototype B to be 31 cm/s, which corresponds to a volumetric air flow rate of about 36 cfm. Accordingly, the collection region of prototype B is expected to operate at close to 100% collection efficiency as long as the air flow rate is below 36 cfm and assuming that the particle mobility distribution is similar to that of prototype A.

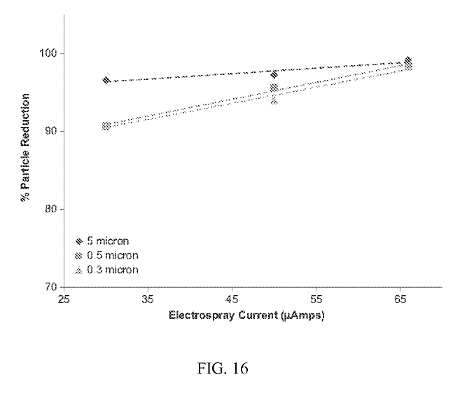

FIG. 16 is a plot of percent particle reduction for 0.3, 0.5, and 5 μm diameter particles in prototype B as a function of electrospray current and at an air flow rate of 24.3 cfm, which is well below the maximum predicted value for prototype B. The particle collection efficiency increased linearly with electrospray current and approaches a value of 100% at an electrospray current of 65 μA. Therefore, it may be concluded that there is a minimum amount of electrospray current required to produce a certain degree of particle ionization at a given air flow rate. From the data of FIG. 16 for prototype B, it was found that the electrospray current must be greater than 65 μm at an air flow rate of 24.3 cfm in order for the total air purification efficiency to approach a value of 100%.

Even though the particle ionization and collection regions were physically separated in both prototypes, there may be some particle collection on the grounded counter electrode in the ionization region. It may be estimated that the maximum amount of particle collection in the ionization region as a percentage of the amount of particle collection in the collection region is less than 7% in prototype A and less than 3% in prototype B when the typical collector voltage is applied.

The typical electrospray liquid flow rate in both prototypes was on the order of 100 nl/min per wick. The flow rate depends on a number of parameters including the solvent properties, wick porosity, the applied electric field, and the air flow rate, which can affect the solvent evaporation rate from the sides of the wick. Nevertheless, using 100 nl/min per wick as a typical liquid flow rate it is possible to estimate factors such as the weekly liquid consumption rate and the concentration of ethanol introduced into an air stream by a large array of wick sources. For example, 1000 wick aerosol sources injecting a 90/10 water/ethanol solution into an air stream with a volumetric flow rate of 100 cfm would consume about 1 liter of solvent per week and, assuming no additional dilution, would result in an ethanol concentration in air of about 1 ppm.

Although the foregoing invention has been described in some detail by way of illustration and example for purposes of clarity and understanding, it will be apparent to those of ordinary skill in the art in light of the teaching of this invention that certain changes and modifications may be made thereto without departing from the spirit or scope of the claims.

What is claimed is:

1. An apparatus for extracting contaminants from an air flow, comprising:
(a) an ionization region defined by an air channel serving as a conduit for an air flow containing a plurality of the contaminants;
(b) a reservoir in communication with the air channel, the reservoir containing a quantity of an aqueous composition;
(c) an electrospray source selected from the group consisting of a plurality of porous polymeric wicks and a plurality of porous polymer ribbons, the electrospray source being connected to the reservoir for generating and dispersing in the ionization region a plurality of charged liquid droplets, with the further proviso that the process of generating the charged droplets does not produce ozone;
(d) a precipitation region in communication with the ionization region, wherein the ionization region and the precipitation region are spatially separated, the precipitation region comprising an electrostatic precipitator for particles collection;
(e) an electric field generator for generating electric fields in the ionization region and the precipitation region, wherein the electric field magnitude and polarity in the ionization region is independent of the electric field in the precipitation region,
wherein the plurality of the contaminants become electrically charged upon the entry of the air flow into the air channel and upon contact with the charged liquid droplets that are dispersed into the ionization region, and wherein the charged contaminants are expelled into the precipitation region and are collected on the electrostatic precipitator,

2. The apparatus of claim 1, wherein the polymeric wicks or porous polymer ribbons are arranged in horizontally disposed arrays.

3. The apparatus of claim 2, wherein the electrostatic precipitator comprises an array of collector plates disposed horizontally or vertically.

4. The apparatus of claim 1, wherein the width of the space separating the ionization region and the precipitation region is between about 1 cm and about 20 cm.

5. The apparatus of claim 1, wherein the aqueous composition comprises water optionally mixed with a substance selected from the group consisting of a water-soluble alcohol, an antibacterial compound, chlorine, a surfactant and mixtures thereof.

6. The apparatus of claim 5, wherein the aqueous composition is a solution containing about 10 mass % of ethanol and the balance of water.

7. The apparatus of claim 5, wherein the aqueous composition further comprises a surfactant.

8. The apparatus of claim 1, wherein the porous polymeric wicks comprise a hydrophilic polymer selected from the group consisting of polyesther, polyethylene, nylon, cellulose or cotton or blends of different polymers.

9. The apparatus of claim 1, wherein the porous polymeric ribbons comprise a hydrophilic polymer selected from the group consisting of polyesther, polyethylene, nylon, cellulose or cotton or blends of different polymers.

10. The apparatus of claim 1, wherein the air flow further comprises at least one gas that is absent from air.

11. The apparatus of claim 1, wherein the strength of the electric field in the precipitation region is between about two times and about three times higher that the strength of the electric field in the ionization region.

12. The apparatus of claim 1, wherein the aqueous composition is delivered to the electrospray source from the reservoir using capillary forces.

13. The apparatus of claim 1, wherein the reservoir is made of an absorbent material.

14. The apparatus of claim 1, wherein the electrostatic precipitator for particles collection is removable.

15. A method for extracting contaminants from an air flow, comprising:
(a) directing the air flow through an apparatus of claim 1;
(b) creating an electric field in the ionization region for generating and dispersing in the ionization region a plurality of charged liquid droplets, with the further proviso that the process of generating the charged droplets does not produce ozone;
(c) allowing the charged liquid droplets to interact with the particles of the contaminants being present in the air flow for transferring the charge from the charged liquid droplets to the particles of the contaminants; and
(e) expelling the charged containments into the precipitation region; and
(f) collecting the charged containments on the electrostatic precipitator,
to thereby extract the contaminants from the air flow.

16. The method of claim 15, further comprising arranging the polymeric wicks or porous polymer ribbons in the apparatus in horizontally disposed arrays.

17. The method of claim 16, further comprising providing the electrostatic precipitator as an array of collector plates disposed horizontally or vertically.

18. The method of claim 15, with the further proviso that in the apparatus the width of the space separating the ionization region and the precipitation region is between about 1 cm and about 20 cm.

19. The method of claim 15, wherein the charged liquid droplets are procured from the aqueous composition comprising water optionally mixed with a substance selected from the group consisting of a water-soluble alcohol, an antibacterial compound, chlorine, a surfactant and mixtures thereof.

20. The method of claim 19, wherein the aqueous composition is a solution containing about 10 mass % of ethanol and the balance of water.

21. The method of claim 19, wherein the aqueous composition further comprises a surfactant.

22. The method of claim 15, further comprising using in the apparatus the porous polymeric wicks comprising a polymer selected from the group consisting of polyesther, polyethylene, nylon, cellulose or cotton or blends of different polymers.

23. The method of claim 15, further comprising using in the apparatus in the apparatus the porous polymeric ribbons comprising a polymer selected from the group consisting of polyesther, polyethylene, nylon, cellulose or cotton or blends of different polymers.

24. The method of claim 15, wherein the air flow further comprises at least one gas that is absent from air.

25. The method of claim 15, further comprising using the strength of the electric field in the precipitation region that is between about two times and about three times higher that the strength of the electric field in the ionization region.

26. The method of claim 15, further comprising delivering the aqueous composition to the electrospray source from the reservoir using capillary forces.

27. The method of claim 15, further comprising using the reservoir made of an absorbent material.

28. The method of claim 15, wherein the electrostatic precipitator for particles collection is removable.
